(19) United States
(12) Patent Application Publication
(10) Pub. No.: US 2025/0251516 A1
(43) Pub. Date: Aug. 7, 2025

(54) POSITIONING SYSTEM WITH LEAKY FEEDER SEGMENTS

(71) Applicant: SYNTONY, TOULOUSE (FR)

(72) Inventors: Benjamin PATOUT, TOULOUSE (FR); Guillaume CARRIÉ, TOULOUSE (FR); Joël KORSAKISSOK, TOULOUSE (FR)

(21) Appl. No.: 18/856,097

(22) PCT Filed: Apr. 4, 2023
(86) PCT No.: PCT/FR2023/050481

§ 371 Date: Oct. 11, 2024

(30) Foreign Application Priority Data
Apr. 11, 2022 (FR) 2203319

(51) Int. Cl. G01S 19/11; G01S 19/28; G01S 19/51

(52) U.S. Cl. CPC G01S 19/11; G01S 19/28; G01S 19/51

(57) ABSTRACT

A positioning system using a plurality of leaky feeder segments. Besides the segments, the system includes a generator generating a composite GNSS signal formed from GNSS signals defined as those that would be received at points located at the ends of the various segments of the cable. In each segment, a first GNSS signal, corresponding to a first set of satellites visible in a first visibility cone, travels along the segment in a forward direction and a second GNSS signal, corresponding to a second set of satellites in a second visibility cone, travels along it in the reverse direction. The frequencies of the first and second GNSS signals being equal to a frequency of reception of a predetermined GNSS system. An RF interconnection box connecting the first and second consecutive segments allows to demultiplex the GNSS signals on the basis of the composite GNSS signal that it receives.

### TECHNICAL FIELD

The present invention relates in general to the field of indoor positioning systems or of outdoor positioning systems when the conditions for reception of the GPS signals are degraded.

### PRIOR ART

The absence of GPS signals in indoor environments has led to developing positioning systems specific to the latter. A large number of possible techniques were used for this purpose. For example, it is known to deploy in the environment in question networks of tags allowing a receiver to estimate its position by TDOA (Time Difference Of Arrival) or by triangulation on the basis of time of arrival, TOA. It is also possible to use existing access points, for example of a Wi-Fi network to determine the position of a terminal on the basis of fingerprints of power measurements (RSSI).

A positioning system based on leaky feeders was proposed by the applicant in the patent application FR3074921.

This positioning system allows any user having available a GPS receiver to be able to locate themselves in an indoor environment such as an underground without having to undergo a rupture of service when they exit or enter this environment.

Such a positioning system with leaky feeders is illustrated in FIG. 1 and its principle is recalled in relation to FIG. 2.

Said system, 100, comprises means 110 for generating first GNSS signals and second GNSS signals, a leaky feeder 120, means for injecting the first GNSS signals at a first end of the cable, 131, and means for injecting the second GNSS signals at a second end of the cable, 132.

The generation means have access to a configuration file, Config_file, navigation data, Nav_data, data of a clock with very low phase jitter, GPS_sync. The configuration file Config_file comprises in particular: a visibility mask for each of the ends of the cable, defined by an angular range for altitude [αmaxₘᵢₙ] and, if necessary, for azimuth [βmaxₘᵢₙ], the respective positions of the ends of the cable and the hardware characteristics of the latter (length, speed of propagation of the electromagnetic waves inside the cable, etc.).

The generation means 110 provide first GNSS signals and second GNSS signals. These first and second GNSS signals are generated locally by simulation of propagation and not real signals received from satellites.

The first GNSS signals are generated in such a way that, at the time at which they are injected at the first end of the cable, they are identical to those that would have been received at a first virtual end in open sky conditions, from a first set of satellites. The first set of satellites is chosen from those of the constellation(s) identified in the configuration file belonging to a first visibility cone defined by an altitude angular interval [αmaxₘᵢₙ] and an azimuth angular interval [βmaxₘᵢₙ], the angles being defined here on the basis of an axis directed from the second end towards the first end of the cable. The first set of satellites comprises at least one such satellite.

Likewise, second GNSS signals are generated in such a way that, at the time at which they are injected at the second end of the cable, they are identical to those that would have been received at the position of a second virtual end, in open sky conditions, from a second set of satellites. The second set of satellites is chosen from those of the constellation identified in the configuration file belonging to a second visibility cone defined by an altitude angular interval [αₘᵢₙ,αₘₐₓ] and an azimuth angular interval [βₘᵢₙ,βₘₐₓ], the angles being defined here on the basis of an axis directed from the first towards the second end of the cable. The second set of satellites comprises at least one such satellite.

The union of the first and of the second sets of satellites comprises at least four satellites, the two sets of satellites being disjoint.

The operating principle is illustrated in FIG. 2 in the elevation view.

The leaky feeder, supposed to be rectilinear, is represented by the line segment [AB] where A and B are the ends of the cable. The first and second visibility cones are represented in C₁ and C₂, as well as a first satellite SV₁ belonging to C₁ and a second satellite SV₂ belonging to the second visibility cone. The distances separating the satellite SV₁ (resp. SV₂) from the ends A and B of the cable are noted as ρ_{A}¹ and ρ_{B}¹ (resp. ρ_{A}² and ρ_{B}²). Likewise, the altitude angles from which the satellite SV₁ (resp. SV₂) is viewed from the ends A and B of the cable are noted as α_{A}¹ and α_{B}¹ (resp. α_{A}² and α_{B}²). It was supposed here that αₘᵢₙ.

A virtual end A′ located on a virtual extension of the cable, on the end A side and at a distance Δ from the latter, is defined. Likewise, an end B′ located on a virtual extension of the cable, on the end B side and at a distance Δ from the latter, is defined. The distance Δ is chosen such that

$$Δ = \frac{L - ℓ}{2} , L = ℓ \frac{c}{v}$$

being the apparent length of the cable, l being its real length, c being the speed of light in a vacuum and v being the speed of propagation of an electromagnetic wave in the cable.

The positioning system injects at the end A of the leaky feeder the signals that would have been received at A′ from the satellites belonging to the first visibility cone C₁. Likewise, it injects at the end B of the leaky feeder the signals that would have been received at B′ from the satellites belonging to the second visibility cone C₂.

It can thus be shown that a user equipped with a GNSS receiver located at a point M will estimate the pseudo-distances separating them respectively from the satellites, SV₁,SV₂, by:

$${\hat{ρ}}_{M}^{1} = {ρ}_{A}^{1} - \frac{L - ℓ}{2} + X + δ = {ρ}_{{A}^{′}}^{1} + X + δ \qquad [ Math . 1 ]$$

$${\hat{ρ}}_{M}^{2} == {ρ}_{B}^{2} + \frac{L + ℓ}{2} - X + δ = {ρ}_{{A}^{′}}^{2} - X + δ \qquad [ Math . 2 ]$$

where=xc/v, x being the abscissa of M on the axis AB and taking A as the origin and δ is the distance equivalent to the clock offset of the GNSS receiver.

On the basis of the pseudo-distances thus estimated for 4 satellites (belonging to the union of the two aforementioned subsets of satellites), the GNSS receiver can determine its position.

The leaky feeder positioning system described above gives satisfactory results but its performance is limited by the length of the cable. Indeed, most current GNSS receivers have a dynamic range of approximately 24 dB, in other words the least powerful satellite signal received cannot be more than 24 dB weaker than the most powerful satellite signal. However, the linear attenuation of the GPS signals in a leaky feeder is approximately 3 to 20 dB/100 m. As a result, a leaky feeder positioning system cannot generally function when the length of the cable exceeds several hundred meters.

This constraint is illustrated in FIG. 3A: when the leaky feeder 320 has a length greater than a critical length, the satellite signals simulated and injected at the first end A are attenuated by more than 24 dB, when they arrive at the end B. Likewise, the satellite signals simulated and injected at the second end B are attenuated by more than 24 dB, when they arrive at the end A. In such a case, it is not possible for a GNSS receiver to estimate its position correctly at the ends of the cable since it cannot acquire the satellite signals coming from the end farthest from the receiver.

One known solution for overcoming this situation is thus to cut the leaky feeder into various segments having a length smaller than the critical length and injecting simulated satellite signals at the respective ends of these segments, as illustrated in FIG. 3B. Each segment 321, 322 must then be considered as an independent leaky feeder, requires specific generation means, which is costly, or a single generator 310 with several RF outputs (here 4) as shown, which does not allow scalability. Moreover, in both cases, the number of coaxial cables (or of optical fibers associated with optoelectronic converters) leads to significant additional costs.

One object of the present invention is consequently to propose a positioning system with several leaky feeder segments not having the aforementioned disadvantages, in particular to propose a system that is scalable and does not require using additional RF or optical links.

The patent applications CN113534196A and CN113534196A also describe positioning systems based on leaky feeders and virtual GNSS signals.

### DESCRIPTION OF THE INVENTION

The present invention is defined by a system for positioning along a leaky feeder, composed of at least a first segment and a second segment, said system comprising:
means for generating a first composite GNSS signal formed from a plurality of GNSS signals defined as those that would be received in an open-sky configuration by points located at the ends of the various segments of the cable, each segment being associated with a first GNSS signal that would be received from a first point at a proximal end of this segment coming from satellites belonging to a first visibility cone, and a second GNSS signal that would be received from a second point at a distal end of this segment coming from satellites belonging to a second visibility cone, said GNSS signals being frequency multiplexed to form said composite GNSS signal, said composite GNSS signal being injected at the proximal end of the first segment, the first GNSS signal associated with the first segment being at the frequency of reception of a GNSS receiver, f_{GNSS};
   an RF interconnection box connected between the first and second segments, intended to demultiplex the first composite GNSS signal by frequency offsetting the various GNSS signals of the first composite signal and to provide, on the one hand, on a first output the second GNSS signal associated with the first segment at the frequency f_{GNSS}, and to provide on the other hand, on a second output, a second composite GNSS signal in which the first and second GNSS signals associated with the first segment are eliminated, the second GNSS signal of the first segment being injected at the frequency f_{GNSS} at the distal end of the first segment and said second composite GNSS signal being injected at the proximal end of the second segment;
   an RF termination box connected to the distal end of the second segment and intended to offset to the frequency f_{GNSS} the second GNSS signal associated with the second segment, and to inject it at the distal end of the second segment.

Advantageously, the GNSS signals of the first composite GNSS signal are located at frequencies f_{GNSS}+iδf where i is an integer.

The RF interconnection box can comprise a first demultiplexer including an RF divider to divide the first composite signal between a first path and a second path, the first path comprising: a first mixer to mix the composite signal thus divided with a first translation frequency (f₁) in such a way that the second GNSS signal of the first segment is translated to an intermediate frequency (IF₀); a first band-pass filter having a first passband (BP₁) around said intermediate frequency to select the second GNSS signal of the first segment thus translated; and a second mixer to mix the second GNSS signal of the first segment thus selected with a first reference frequency (f₁^{ref}) so as to transpose said signal to the frequency f_{GNSS}.

The second path can comprise a third mixer to mix the divided composite signal with a second translation frequency (f₂) in such a way that a second composite GNSS signal is translated to the intermediate frequency (IF₀); a second band-pass filter having a second passband (BP₂) around said intermediate frequency to select the second composite GNSS signal; and a fourth mixer to mix the second composite GNSS signal with a second reference frequency (f₂^{ref}) so as to transpose said signal to the frequency f_{GNSS},

The first path can further comprise a third band-pass filter intended to filter the second GNSS signal of the first segment and that the second path also comprises a fourth band-pass filter intended to filter the second composite GNSS signal.

The RF interconnection box can further comprise a duplexer, the shared port of which is connected to the distal end of the first segment, the output port of which is connected to the input of the RF divider and the input port of which is connected to the output of the second mixer of the first path.

The RF interconnection box can further comprise, between the output port of the duplexer and the input of the RF divider, a shared band-pass filter having the bandwidth of the first composite signal in series with an amplifier, the gain of the amplifier being chosen to compensate for the attenuation of the composite GNSS signal in the first segment.

According to an alternative embodiment, the leaky feeder is composed of a plurality N of segments, the RF termination box thus comprising: a first mixer at an Nth translation frequency (f_{N}) so that the second GNSS signal of the Nth segment is translated to an intermediate frequency (IF₀), a first band-pass filter having a first passband (BP₁) around said intermediate frequency to select the second GNSS signal of the Nth segment thus translated, and a second mixer to mix the second GNSS signal of the Nth segment thus selected with an Nth reference frequency (f_{N}^{ref}) so as to transpose said signal to the frequency f_{GNSS}.

The RF termination box can thus further comprise a duplexer, the shared port of which is connected to the distal end of the Nth segment, the output port of which is connected to the input of the first mixer and the input port of which is connected to the output of the second mixer.

The RF termination box can further comprise, between the output port of the duplexer and the input of the RF divider, a second band-pass filter, having the bandwidth of the last composite signal associated with the Nth segment, called last segment, followed by an amplifier, the gain of the amplifier being chosen to compensate for the attenuation of the last composite GNSS signal in the last segment.

The means for generating the composite GNSS signal can also generate in this signal at least two synchronization signals having a frequency gap of δf, each synchronization signal being obtained by modulating a continuous wave with a pseudo-random spectral spreading sequence, said random sequence being chosen identical for all of the synchronization signals.

The central frequencies of the synchronization signals are advantageously located in zones of low spectral density of the first composite GNSS signal.

The RF interconnection box as well as the RF termination box can each comprise a circuit for generating a clock signal comprising a mixer to multiply the composite signal by itself, a low-pass or band-pass filter so as to isolate from the mixture a component at the frequency δf.

### BRIEF DESCRIPTION OF THE DRAWINGS

Other features and advantages of the invention will appear upon reading a preferred embodiment of the invention, made in reference to the appended drawings in which:

FIG. 1 schematically shows a system for positioning along a leaky feeder known from the prior art;

FIG. 2 schematically shows the operating principle of the positioning system illustrated in FIG. 1;

FIG. 3A illustrates a constraint related to a leaky feeder positioning system known from the prior art;

FIG. 3B shows a solution allowing to overcome this constraint;

FIG. 4 schematically shows a positioning system using 2 leaky feeder segments according to a first exemplary embodiment of the invention;

FIG. 5A-5C schematically show an RF interconnection device and an RF termination device of FIG. 4, as well as the signals present at various points of these devices;

FIG. 6A-6C schematically show a positioning system using 4 leaky feeder segments according to various exemplary embodiments of the invention;

FIG. 7 schematically shows an RF interconnection device of FIG. 6C;

FIG. 8 schematically shows the spectrum of a composite signal injected into a leaky feeder comprising GNSS signals and synchronization signals; and

FIG. 9 schematically shows a circuit for generating a frequency transposition signal from the composite signal of FIG. 8.

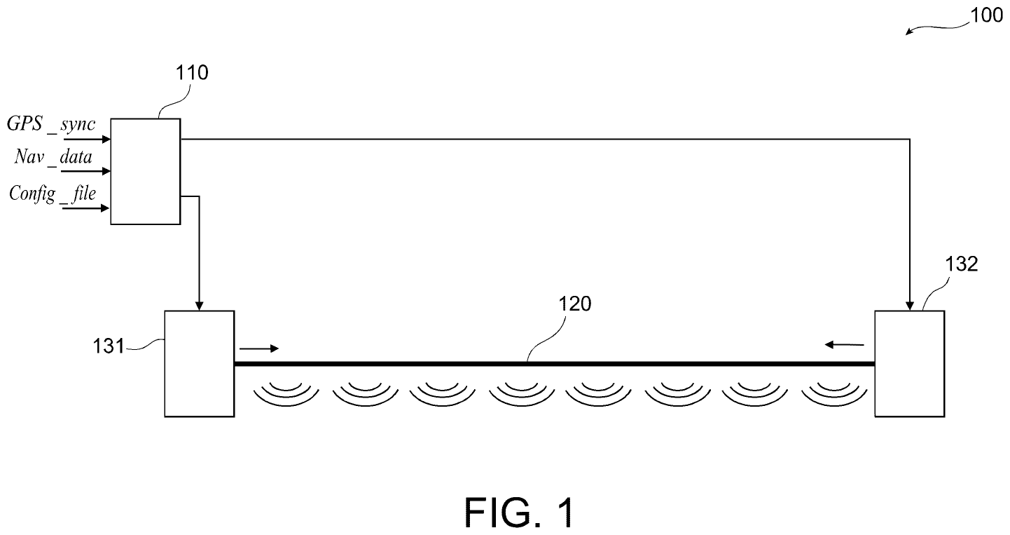

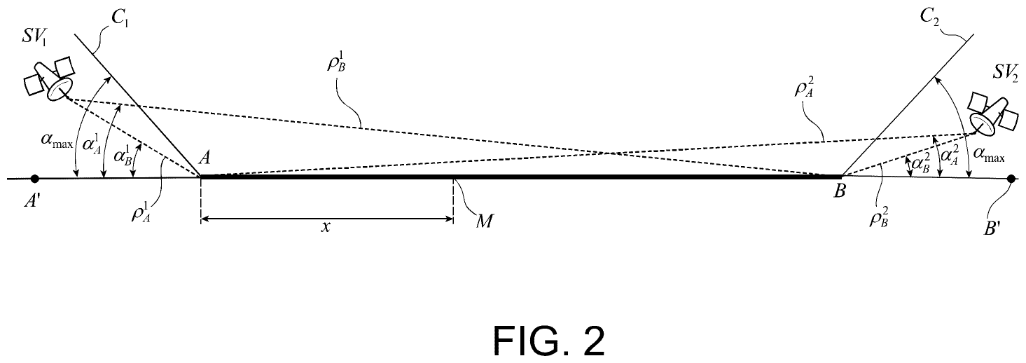

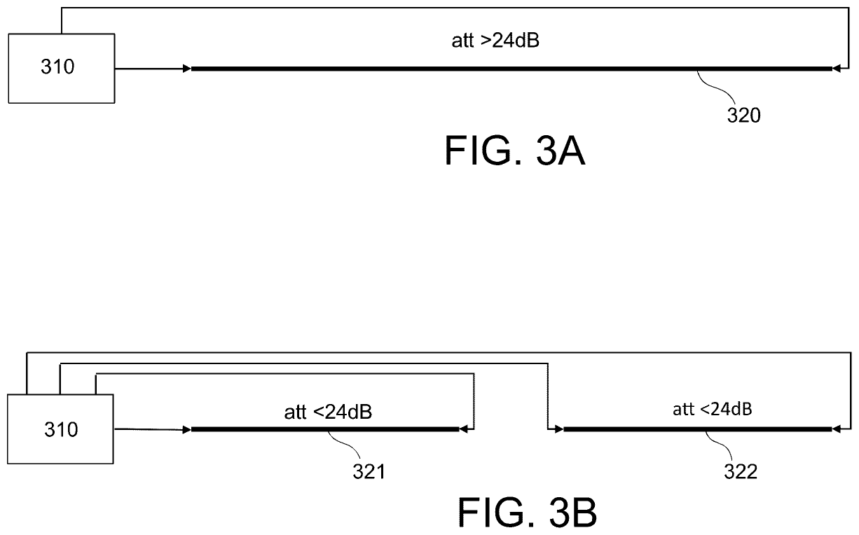

### DESCRIPTION OF THE EMBODIMENTS

A leaky feeder positioning system as presented in the introductory part will be considered below.

Leaky feeder means in particular a coaxial cable, the outside conductor of which has slots or openings at regular intervals so as to allow a radial emission over its entire length. In an equivalent manner, any waveguide, with slots or with openings, having a large extension along its longitudinal axis and allowing a radial emission along this entire axis can be used.

The leaky feeder can be linear or have curved sections.

It is supposed that the leaky feeder is split into several distinct segments having equal or distinct lengths, the length of each segment being chosen as less than a critical length. Critical length means a length such that the attenuation of a GNSS signal in a segment of this length corresponds to the maximum acceptable difference in power (in dB) between GNSS signals allowing their simultaneous acquisition by a GNSS receiver.

In general, GNSS (Global Navigation Satellite System) signals means here any type of satellite signals allowing a positioning, regardless of the system considered (GPS, Galileo, GLONASS, Beidou, etc.).

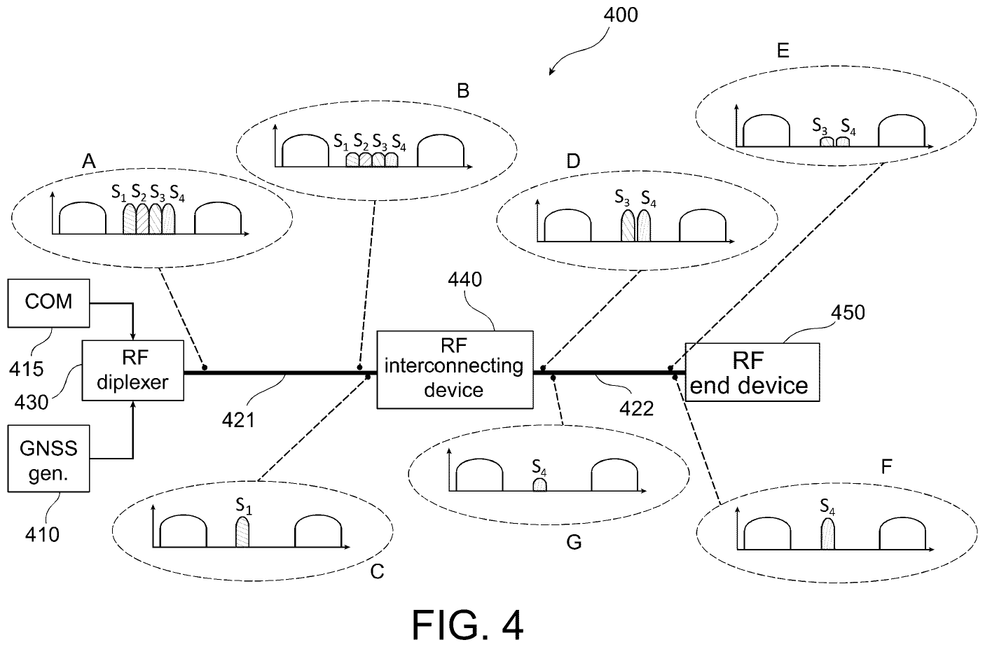

FIG. 4 schematically shows a positioning system using 2 leaky feeder segments according to a first exemplary embodiment of the invention.

The first leaky feeder segment, 421, is connected to the shared output of a diplexer, 430, receiving on the one hand, in a first band, GNSS signals generated by simulation coming from the generator 410, and on the other hand, in second bands, mobile communication signals intended for the various users, coming from the communication module 415. Thus, advantageously, a single signal output is necessary for the 2 segments 421 and 422. The diplexer 430 can be carried out on the basis of an RF divider supplied by the outputs and thus providing at its input a combination of the GNSS signals and of the mobile communication signals.

The GNSS signals are represented here at 4 distinct frequencies separated from each other by a step of δf 10 MHz: 1565.42 MHz, 1575.42 MHz, 1585.42 MHz and 1595.42 MHz. It is clear to a person skilled in the art that other frequencies can be used, for example 1575.42 MHz, 1585.42 MHz, 1595.42 MHz and 1605.42 MHz.

Only the frequency f_{GNSS} (here f_{GNSS}=1575.42 MHz, frequency L1 of a GPS system) can be used by the receivers of the users, the other frequencies not being taken into account in the pursuit algorithm by such a receiver. These other frequencies simply have the object of transporting the GNSS signals in the leaky feeder. In general, these frequencies can take values of f_{GNSS}+iδf where i is an integer. In certain cases, there can be an exemption to this constraint, the frequencies used for the transport thus having any given offset with respect to the frequency f_{GNSS}.

In the example illustrated (diagram A), only the signal s₂ at the frequency f_{GNSS}, emitted on the path of forward propagation in the cable segment 421, can be used by a receiver to determine its position. The effect of the attenuation after propagation in the cable should be noted (diagram B). The RF interconnection box, 440, sends back, as explained below, the signal s₁ transposed to the frequency f_{GNSS} in the first segment, 421 (diagram C). Thus, for a user, everything happens as if the signal s₂ was injected at the first end, called proximal end of the segment 421, and the signal s₁ was injected at its second end, called distal end. The RF interconnection box further injects into the second segment 422 the remaining GNSS signals, namely those that were not transmitted at the frequency f_{GNSS}, in the first segment, 421, or s₃, s₄, are injected at the proximal end of the second segment.

The signal s₃ is transmitted at the frequency f_{GNSS} on the path of forward propagation in the second segment, 422. The attenuation of the signals s₃, s₄ after having propagated in the second segment is noted. The RF termination box, 450, send back the signal s₄ transposed to the frequency f_{GNSS} in the segment 421 (diagram F). Thus, for the receiver of a user, everything happens as if the signal s₃ was injected at the proximal end of the second segment 422 and the signal s₄ was injected at its distal end.

According to an alternative not shown in this drawing, the signal s₄ can be transmitted at the frequency f_{GNSS} on the path of forward propagation in the second segment, 422, and, in this case, the RF termination box, 450, sends back the signal s₃ transposed to the frequency f_{GNSS} in the segment 421.

Moreover, the RF interconnection box 440 as well as the RF termination box, 450, can be directly supplied with energy via the leaky feeder segments 421, 422.

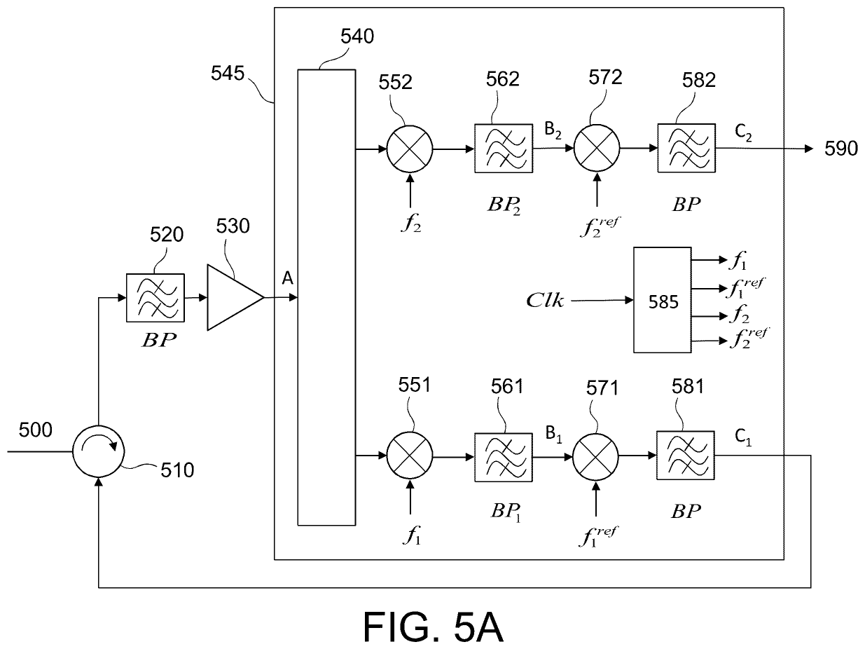

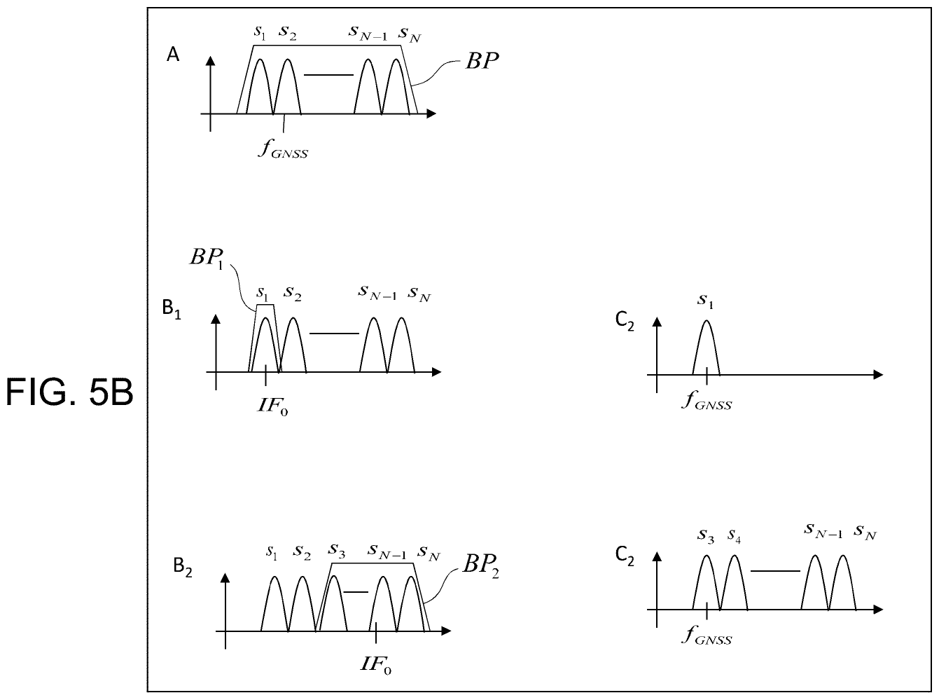

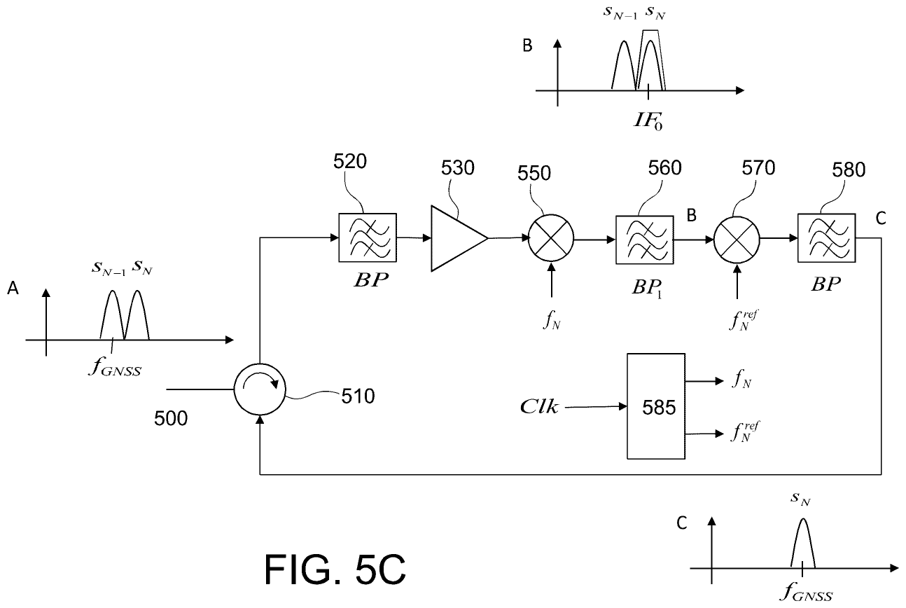

The detail of the RF interconnection box of FIG. 4 has been schematically shown in FIG. 5A.

The box comprises a first RF port, 500, intended to be connected to the first leaky feeder segment, 421, and a second RF port 590 intended to be connected to the second leaky feeder segment, 422. More generally, the RF ports 500 and 590 can be connected respectively to the distal end and the proximal end of two consecutive segments, the proximal or distal nature being determined by reference to the generator of GNSS signals.

The number N of GNSS signals generated is equal to double the number of segments (N=4).

The RF port 500, called shared port, is connected to a duplexer 510, the composite GNSS signal, formed by the signals s₁, . . . , s₄ received on this port, being filtered by a band-pass filter, 520, the passband of which, BP, corresponds to the band of the GNSS signals, then amplified by an amplifier, 530.

The gain of the amplifier 530 is advantageously chosen so as to compensate for the attenuation in the first leaky feeder segment, 421. The spectrum of the composite GNSS signal at the output of the amplifier 530 is illustrated in diagram A of FIG. 5B: it is noted that the spectrum of the signal s₂ is centered here on the frequency f_{GNSS}, in other words the signal s₂ was at the frequency f_{GNSS} during its propagation in the first segment.

The composite GNSS signal thus amplified is then provided to an RF divider, 540.

On a first branch at the output of the RF divider, the signal is mixed, via a mixer 551, with a first translation frequency f₁ to bring the signal s₁ to an intermediate frequency, IF₀ (here f₁=f_{GNSS}−IF₀−δf). The intermediate frequency can be chosen as equal to a multiple of δf. According to one exemplary embodiment δf=10 MHz and IF₀=70 MHz.

The intermediate-frequency signal thus obtained is filtered via a band-pass filter, 561, with a narrow passband, BP₁, centered on the frequency IF₀, to select the signal s₁, as shown in diagram B₁ of FIG. 5B. The signal at the output of the filter 561 is then mixed with a first reference frequency, f₁^{ref}, to bring the signal s₁ to the frequency f_{GNSS}. The signal thus mixed is filtered via the band-pass filter, 581, having a bandwidth, BP, before being send back towards the duplexer to be injected at the distal end of the first cable segment. As can be observed in diagram C₁ of FIG. 5B, the signal at the output of the filter 581 now only includes the signal s₁, centered on the frequency f_{GNSS}. This signal propagates in the first cable segment in the return direction.

On a second branch at the output of the RF divider, the signal is mixed, via a mixer 552, with a second translation frequency f₂ to center the spectrum of all the signals s₃, . . . , s_{N} at the intermediate frequency IF₀. The intermediate-frequency signal thus obtained is filtered via a band-pass filter 562, the bandwidth of which, BP₂, allows to select all of the remaining signals s₃, . . . , s_{N}, as shown in diagram B₂ of FIG. 5B.

The signal at the output of the filter 562 is then mixed with a second reference frequency f₂^{ref} in the mixer 572, then filtered via the band-pass filter, 582, having a passband, BP, before being injected into the second cable segment. As can be observed in diagram C₂ of FIG. 5B, the second composite signal at the output of the filter 582 now only includes the GNSS signals s₃, s₄, . . . , s_{N}, the signal s₃ thus being centered on the frequency f_{GNSS}. The second composite signal propagates in the second cable segment, in the forward direction.

According to an alternative not shown, mentioned here in relation to FIG. 4, the second reference frequency of the mixer 572 can be chosen so that the signal s₄ is centered on the frequency f_{GNSS}. The second composite signal at the output of the filter 582 includes the same GNSS signals as above but offset by −δf. It is noted that, in this alternative, the shape of the second composite signal is similar to that of the first composite signal and consequently, the chaining of the cable segments can be iterated while keeping the same principle of band-pass filtering at the intermediate frequency then of transposition to the frequency f_{GNSS}.

Other alternatives of the RF interconnection box are also possible for a person skilled in the art without going beyond the context of the present invention. For example, the band-pass filter 520 and the amplifier 530 can be placed on each of the paths. Moreover, amplifiers can be provided on each of the paths so as to compensate for the attenuation in the RF divider and the band-pass filters 561, 581, resp. 562, 582.

The detail of the RF termination box of FIG. 4 has been schematically shown in FIG. 5C.

The RF termination box is connected to the distal end of the last leaky feeder segment starting from the generator of GNSS signals. When the structure of the positioning system is a tree as illustrated below, an RF termination box is provided in each leaf of the tree.

The RF termination box comprises an RF port, 500, intended to be connected to the cable segment in question. The RF port 500 is connected to a duplexer 510, the composite GNSS signal, formed here by the signals s_{N-1}, s_{N} (for example s₃, s₄ in the example of FIG. 4) received on this port, is filtered by the band-pass filter 520, having a passband BP, then provided to the amplifier 530. The gain of the amplifier is here again advantageously chosen so as to compensate for the attenuation in the leaky feeder segment, 422. The spectrum of the composite signal is illustrated in diagram A, the spectrum of the signal s_{N-1} being centered on the frequency f_{GNSS}. It is thus understood that the signal s_{N-1} was at the frequency f_{GNSS} during its forward propagation in the segment 422.

Without losing generality, it is supposed here that N=4 and the general case will be given between parentheses). The second amplified composite signal is then mixed in the mixer 550 with a third translation frequency f₃ (more generally with an Nth translation frequency f_{N}) to bring the signal s₄ (more generally the signal s_{N}) to the intermediate frequency IF₀. The signal at the output of the mixer 550 is then filtered by the band-pass filter 560, having a passband BP₁ centered on IF₀ to select the last GNSS signal remaining in this case here the signal s₄. The signal filtered by the filter 560 is then mixed, in the mixer 570, with a third reference frequency, f₃^{ref}, (more generally f_{N}^{ref}) to transpose the signal s₄ to the frequency f_{GNSS}.

The signal s₄ (s_{N}) thus frequency transposed is filtered via the band-pass filter, 580, having a passband, BP. This signal is provided to the duplexer 510 which injects it at the distal end of the second segment, in such a way that it propagates therein in the return direction.

Alternatively, according to the second aforementioned alternative if the signal s₄ (s_{N}) was at the frequency f_{GNSS} during its forward propagation in the segment 422, the third translation frequency would be chosen so as to bring the signal s₃ (more generally the signal s_{N-1}) to the intermediate frequency IF₀. The band-pass filter 560 would then select the signal s₃ (s_{N-1}) with the passband BP₁ and the mixer 570 would use the same third reference frequency f₃^{ref} to transpose the signal s₃ to the frequency f_{GNSS}.

Finally, other alternatives of the RF termination box are possible for a person skilled in the art without going beyond the context of the present invention. Thus, for example it is possible to provide an additional amplifier before injection in the input port of the duplexer, so as to compensate for the attenuation undergone by the signal in the band-pass filters 560 and 580.

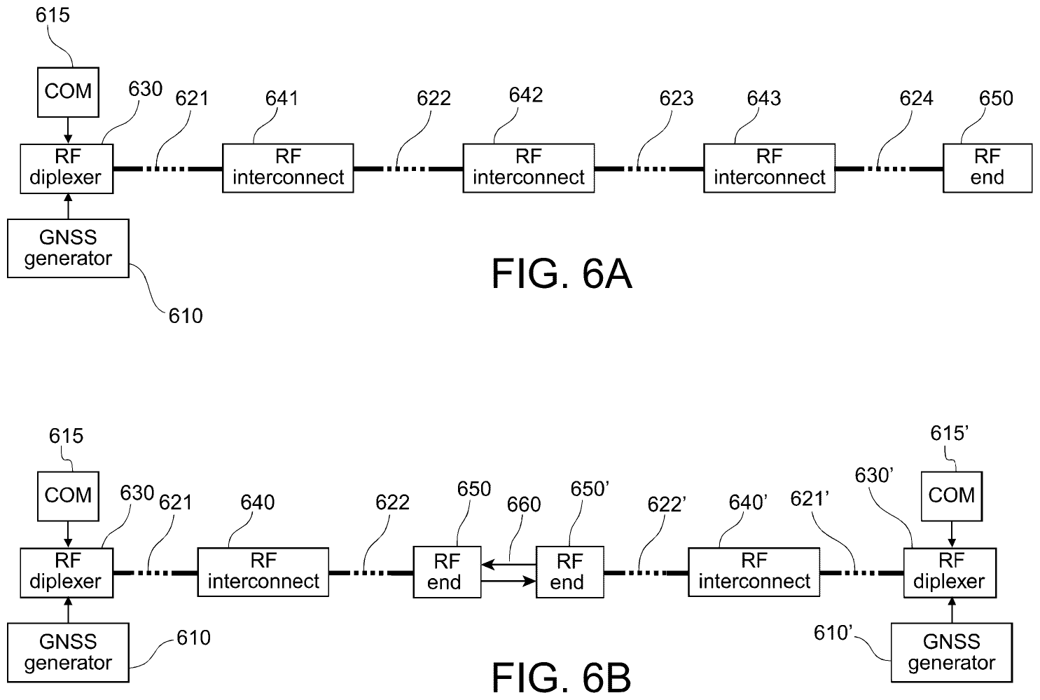

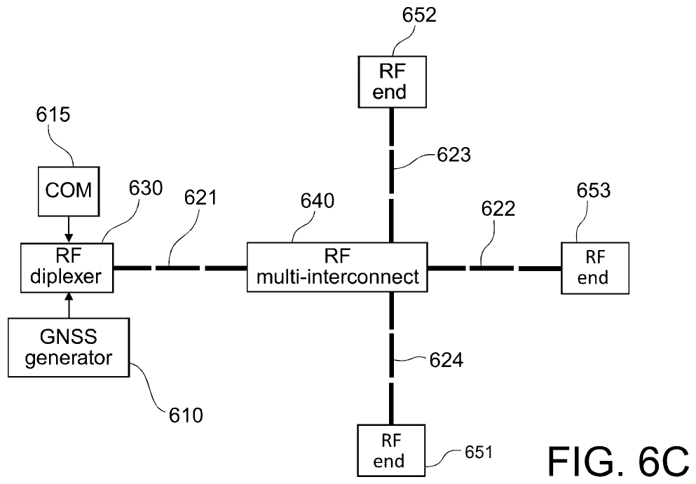

FIG. 6A schematically shows a positioning system using 4 leaky feeder segments according to a first exemplary embodiment of the invention.

This exemplary embodiment is an extension with 4 segments of the embodiment of FIG. 4, the elements 610, 615, 630 respectively having the same functions as the elements 410, 415, 430. The RF interconnection boxes 641, 642, 643 also have the same function as the RF interconnection box 440, the structure of which is represented in FIG. 5A. Finally, the RF termination box 650 has the same function as the RF termination box 450, the structure of which was shown in FIG. 5C.

Unlike the embodiment of FIG. 4, the generator of GNSS signals provides 8 signals s₁, s₂, . . . , s₇, s₈ here.

In this embodiment, the signals s₁, s₂ are emitted at the frequency f_{GNSS} by the first segment (respectively in the return and forward direction of propagation), and, if the aforementioned variant is adopted, the signals s₃, s₄ are emitted at this same frequency by the second segment (respectively in the return and forward direction of propagation), etc., and finally the signals s₇, s₈ are emitted at the frequency f_{GNSS} by the last segment (respectively in the return and forward direction of propagation).

FIG. 6B schematically shows a positioning system using 4 leaky feeder segments according to a second exemplary embodiment of the invention.

This exemplary embodiment differs from the first in that it comprises two positioning systems with 2 segments of the type illustrated in FIG. 4, mounted top to tail. The first positioning system consists of the elements designated by 610-650 and the second consists of the elements designated by 610′-650′. The elements 610 to 650, on the one hand, and 610′ to 650′, on the other hand, are identical to the elements 410 to 450 of FIG. 4.

Thus, the GNSS generator 610′, like the generator 610, generates 4 GNSS signals s₁′, s₂′, s₃′, s₄′, the signals s₁′, s₂′ being emitted at the frequency f_{GNSS} by the first segment 621′ (respectively in the return and forward direction of propagation) and the signals s₃′, s₄′ being emitted at this same frequency by the second segment (respectively in the forward and return direction; and inversely in the case of the aforementioned variant). The communication signals 660 can be transmitted between the RF termination boxes 650 and 650′, so as to ensure their availability along the 4 segments.

FIG. 6C schematically shows a positioning system using 4 leaky feeder segments according to a third exemplary embodiment of the invention.

The elements 610, 615, 630 are identical to those carrying the same references in FIG. 6A.

The third exemplary embodiment differs from the first in that its configuration is no longer linear but a tree. It uses an RF box for multiple interconnections to the 4 leaky feeder segments. Other configurations, in particular mixed configurations of the linear/tree type are possible for a person skilled in the art without going beyond the context of the present invention.

In the case illustrated, each of the leaves of the tree is equipped with an RF termination box, namely the boxes 651, 652, 653.

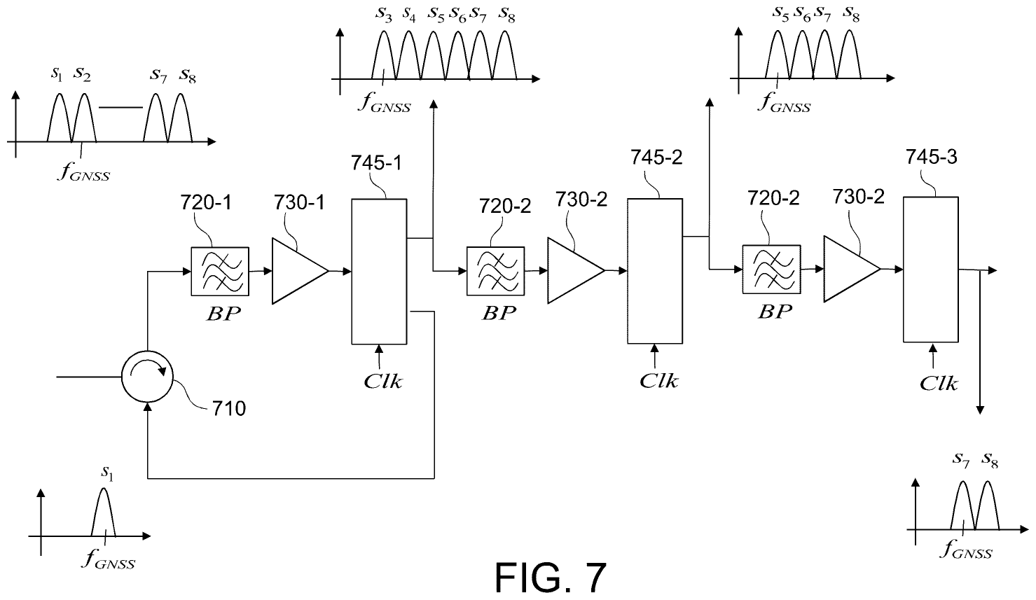

FIG. 7 schematically shows the multiple RF termination box of FIG. 6C.

This interconnection box includes, like that shown in FIG. 5A, a duplexer 710, a first band-pass filter, 720-1, a first amplifier 730-1, as well as a first demultiplexer 745-1, respectively having the same functions as the duplexer 510, the band-pass filter 520, the amplifier 530 and the demultiplexer 545 of FIG. 5A.

However, unlike the interconnection box of FIG. 5A, the multiple interconnection box comprises a second demultiplexer 745-2 and a third multiplexer 745-3 in series.

The first demultiplexer 745-1 translates the spectrum of the composite GNSS signal so as to center the signal s₃ on the reception frequency f_{GNSS}, and respectively provides on its first output the signal s₁, reinjected in the segment 621, and on its second output a second composite signal formed from the signals s₃-s₈, this second composite signal being injected in the segment 623.

The second demultiplexer 745-2 translates the spectrum so as to center the signal s₅ on f_{GNSS} and provide at the output a third composite signal formed from the signals s₅-s₈, this third composite signal being injected in the segment 624.

Finally, the third demultiplexer 745-3 translates the spectrum so as to center the signal s₇ on f_{GNSS} and provide at the output a fourth composite signal formed from the signals s₇-s₈, this fourth composite signal being injected in the segment 622.

It is understood that unlike the demultiplexer 545, the demultiplexers 745-2 and 745-3 only comprise one output, corresponding to that of the first branch of the demultiplexer 545.

In general, the demultiplexers ensure the changes in frequency of the GNSS signals in the composite signals, typically via a frequency offset. Since the GNSS signals are regularly spaced apart by a difference δf in the spectrum of the composite GNSS signal, and the intermediate frequency is advantageously chosen as equal to a multiple of this difference, the various translation frequencies f₁ . . . f_{N} as well as the various reference frequencies f₁^{ref} . . . f_{N}^{ref} can be generated from a clock signal at the frequency δf. In other words, this clock signal can be used as the base signal from which the translation and reference frequencies are generated in a programmable manner.

A first approach could involve transmitting the clock signal with the GNSS signals from one segment to the other. However, if this frequency is radiated by the cable segments, an authorization to emit at this frequency and a radio certification can be necessary. This frequency can further by forbidden because it is already used for other purposes by other equipment of the user and can thus disturb the operation of the latter by interference. Finally, the signals propagating in the forward and return directions, intended for the GNSS receiver, must be perfectly at the same frequency f_{GNSS}.

According to an advantageous embodiment of the invention, the clock signal is generated in each interconnection box by mixing at least two “synchronization” signals. These synchronization signals are obtained by modulating two continuous waves, separated by a difference δf, by a shared frequency spreading sequence having a low frequency relative to that of the C/A codes, in other words that of the pseudo-random sequences (PRN) used in the GNSS signals.

FIG. 8 schematically shows the spectrum of a composite GNSS signal injected into a leaky feeder, this signal comprising both the GNSS signals (here two GPS signals) and synchronization signals.

The GNSS signals were represented in 810 and 820 and the synchronization signals were represented in 830 and 840. The frequency gap between the GNSS signals is equal to that between the synchronization signals (here δf=10 MHz). It is noted that the spectral spreading of the synchronization signals is much less than that of the GNSS signals. The use of spectrally spread synchronization signals allows to reduce the level of interference in the environment. The synchronization signals can be placed arbitrarily in non-occupied zones of the spectrum. Advantageously, the synchronization signals can be located far from the central frequency f_{GNSS}, in holes of the spectral density of the GNSS signal (zeros of the sinc function). This precaution allows to improve the signal-to-noise ratio, both of the GNSS signals and of the clock signal.

The clock signal Clk can be obtained by multiplying the synchronization signals by each other, for example the synchronization signals 830 and 840 as explained below.

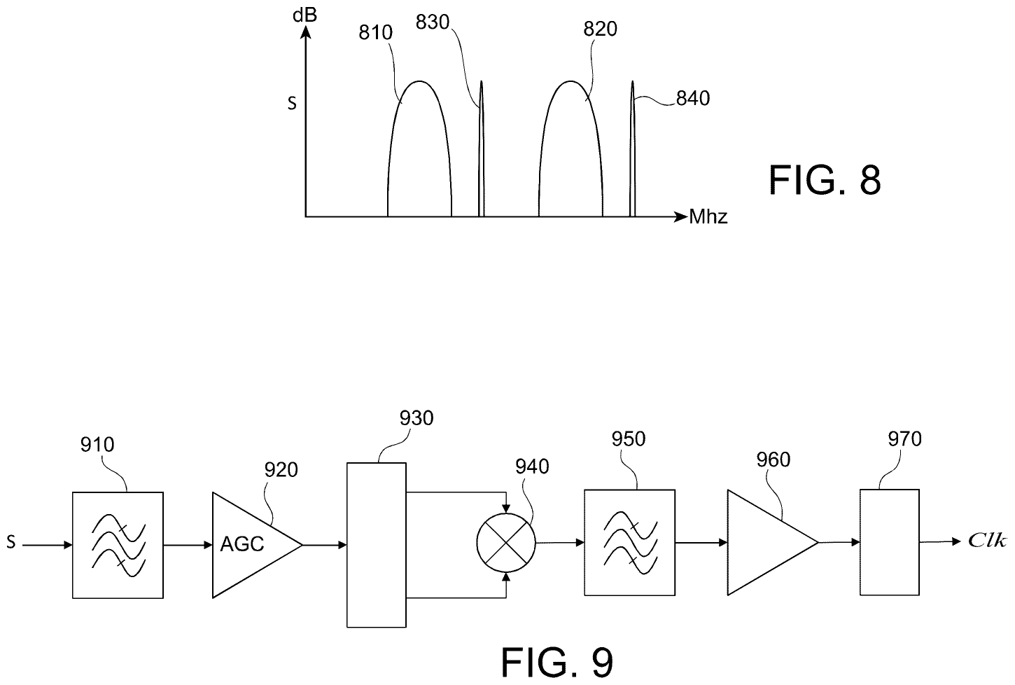

FIG. 9 schematically shows a circuit for generating a clock signal from the composite signal shown in FIG. 8.

The generation circuit receives the aforementioned composite signal, comprising the GNSS signals and the synchronization signals. This composite signal is filtered by a first band-pass filter 910 (isolating the band of the GNSS signals, for example a filter centered on the frequency L1 in the case of a GPS system) so as to improve the signal-to-noise ratio in the processing chain.

The composite signal thus filtered is then amplified in an amplifier with automatic gain control (AGC), 920, divided in 2 by a power divider, 930, then multiplied by itself in a mixer 940 (or a component with a non-linear characteristic). Given that the synchronization signals are modulated via the same pseudo-random sequence, the product of two such signals centered on two frequencies f_{sync}¹ and f_{sync}²=f_{sync}¹+δf gives, on the one hand, a continuous wave at the (beat) frequency Δf and, on the other hand, a continuous wave at the frequency 2f_{sync}¹+δf, the latter being eliminated here by a second band-pass filter, 950, centered on δf. Indeed, the multiplication of a pseudo-random sequence (expressed in BPSK form) by itself gives a constant value. The signal at the output of the second band-pass filter is then amplified in the amplifier 960 then, if necessary, injected into a phase-locked loop 970 to reduce the jitter. The signal at the output of the clock generation circuit is a stable continuous wave at the frequency δf that can be used as a base signal to generate the frequencies provided to the various mixers as described above.

1-13. (canceled)

14. A system to position along a leaky feeder, the leaky feeder comprising at least a first segment and a second segment, the system comprising:
a generator to generate a first composite global navigation satellite system (GNSS) signal formed from a plurality of GNSS signals defined as those that would be received in an open-sky configuration by points located at ends of the segments of the leaky feeder, each segment being associated with a first GNSS signal that would be received from a first point at a proximal end of said each segment coming from first satellites belonging to a first visibility cone, and a second GNSS signal that would be received from a second point at a distal end of said each segment coming from second satellites belonging to a second visibility cone, said plurality of GNSS signals being frequency multiplexed to form the first composite GNSS signal, the first composite GNSS signal being injected at the proximal end of the first segment, the first GNSS signal associated with the first segment being at a reception frequency of a GNSS receiver, f_{GNSS};
an RF interconnection box, connected between the first and second segments, to demultiplex the first composite GNSS signal by a frequency offsetting said plurality of GNSS signals of the first composite GNSS signal and to provide the second GNSS signal associated with the first segment at the frequency f_{GNSS} on a first output and to provide a second composite GNSS signal in which the first and second GNSS signals associated with the first segment are eliminated on a second output, the second GNSS signal of the first segment being injected at the frequency f_{GNSS} at the distal end of the first segment, and the second composite GNSS signal being injected at the proximal end of the second segment; and
an RF termination box, connected to the distal end of the second segment, to offset to the frequency f_{GNSS}, the second GNSS signal associated with the second segment, and to inject the second GNSS signal at the distal end of the second segment.

15. The system for positioning along the leaky feeder of claim 14, wherein the plurality of GNSS signals of the first composite GNSS signal are located at frequencies f_{GNSS}+iδf where i is a relative integer.

16. The system for positioning along the leaky feeder of claim 15, wherein the RF interconnection box comprises a first demultiplexer comprising an RF divider to divide the first composite GNSS signal between a first path and a second path, the first path comprising: a first mixer to mix the first composite GNSS signal thus divided with a first translation frequency such that the second GNSS signal of the first segment is translated to an intermediate frequency; a first band-pass filter comprising a first passband around the intermediate frequency to select the second GNSS signal of the first segment thus translated; and a second mixer to mix the second GNSS signal of the first segment thus selected with a first reference frequency so as to transpose said signal to the frequency f_{GNSS}.

17. The system for positioning along the leaky feeder of claim 16, wherein the second path comprises a third mixer to mix the first composite GNSS signal divided with a second translation frequency such that the second composite GNSS signal is translated to the intermediate frequency; a second band-pass filter comprising a second passband around the intermediate frequency to select the second composite GNSS signal; and a fourth mixer to mix the second composite GNSS signal with a second reference frequency so as to transpose the second composite GNSS signal to the frequency f_{GNSS}.

18. The system for positioning along the leaky feeder of claim 16, wherein the first path further comprises a third band-pass filter to filter the second GNSS signal of the first segment; and wherein the second path further comprises a fourth band-pass filter to filter the second composite GNSS signal.

19. The system for positioning along the leaky feeder of claim 16, wherein the RF interconnection box further comprises a duplexer, a shared port connected to the distal end of the first segment, an output port connected to an input of the RF divider and an input port connected to an output of the second mixer of the first path.

20. The system for positioning along the leaky feeder of claim 19, wherein the RF interconnection box further comprises, between an output port of the duplexer and an input of the RF divider, a shared band-pass filter comprising a bandwidth of the first composite GNSS signal in series with an amplifier, a gain of the amplifier being chosen to compensate for an attenuation of the first composite GNSS signal in the first segment.

21. The system for positioning along the leaky feeder of claim 15, the leaky feeder comprising a plurality N segments, wherein the RF termination box comprises: a first mixer at an Nth translation frequency so that the second GNSS signal of the Nth segment is translated to an intermediate frequency, a first band-pass filter comprising a first passband around the intermediate frequency to select the second GNSS signal of the Nth segment thus translated, and a second mixer to mix the second GNSS signal of the Nth segment thus selected with an Nth reference frequency so as to transpose the second GNSS signal to the frequency f_{GNSS}.

22. The system for positioning along the leaky feeder of claim 21, wherein the RF interconnection box further comprises a duplexer, a shared port connected to the distal end of the Nth segment, an output port connected to an input of the first mixer and an input port connected to an output of the second mixer.

23. The system for positioning along the leaky feeder of claim 22, wherein the RF termination box further comprises, between an output port of the duplexer and an input of the RF divider, a second band-pass filter comprising a bandwidth of a last composite GNSS signal associated with the Nth segment, referred to as a last segment, followed by an amplifier, a gain of the amplifier being chosen to compensate for an attenuation of a last composite GNSS signal in a last segment.

24. The system for positioning along the leaky feeder of claim 15, wherein the generator is configured to generate in the first composite GNSS signal at least two synchronization signals comprising a frequency gap of of, each synchronization signal being obtained by modulating a continuous wave with a pseudo-random spectral spreading sequence, the pseudo-random spectral spreading sequence being chosen identical for all synchronization signals.

25. The system for positioning along the leaky feeder of claim 24, wherein central frequencies of said at least two synchronization signals are located in zones of a low spectral density of the first composite GNSS signal.

26. The system for positioning along the leaky feeder of claim 24, wherein each of the RF interconnection box and the RF termination box comprises a clock circuit to generate a clock signal, the clock circuit comprising a mixer to multiply the first composite GNSS signal by itself, and a low-pass or band-pass filter to isolate from the mixture a component at the frequency δf.
